(19) United States
(12) Patent Application Publication
(10) Pub. No.: US 2017/0273257 A1
(43) Pub. Date: Sep. 28, 2017

(54) ENCAPSULATED AND SEGREGATED GROWTH CONTAINERS

(71) Applicant: David Hauser, Merrick, NY (US)

(72) Inventor: David Hauser, Merrick, NY (US)

(21) Appl. No.: 15/082,217

(22) Filed: Mar. 28, 2016

(51) Int. Cl. A01G 13/02; A01G 1/00; A01G 9/24; A01G 25/00; A01G 17/00

(52) U.S. Cl. CPC A01G 13/0237; A01G 25/00; A01G 13/0212; A01G 17/00; A01G 13/0231; A01G 9/246; A01G 1/001; A01G 1/002

(57) ABSTRACT

An agricultural yield pod or agricultural yield pad with holed root membrane overlay. The agricultural yield pod encloses soil and vegetation in the soil. The top of the agricultural yield pod is closed except for at least one water and nutrition port and at least one vegetation growth port (or neck). The trunk of the vegetation passes through the at least one vegetation growth port (or neck). The agricultural yield pad is closed by the holed root membrane overlay and contains soil and vegetation in the soil. The trunk of the vegetation passes through the holes in the holed root membrane overlay. Root direction channels 38 may be beneath the overlay.

### BACKGROUND OF THE INVENTION

Agriculture is clearly important to the whole of humanity. Agriculture is a primary source of oxygen creation, core to hosts of economies and industries around the globe, and one of several primary sources of the world's food supply.

Industrial, large-scale, commercial farms and individual, small-scale residential gardens share a number of common challenges and traits. At both ends of this spectrum, the successes of agricultural yield are primarily functions of water, nutrients, pest control, and ambient temperature, humidity, and sunlight. Advances have been made in each of these areas from creative ways to reduce water wastages and recapturing of water for reuse, innovative nutrient supply systems, non-chemical approaches to pest control, artificial lighting, and even indoor-farming environments and methods. With implementation of these, and many other innovations, agricultural yield has improved drastically as has the hardiness of vegetation in agriculturally suboptimal environments. But hosts of challenges remain.

The process of watering in all of its most common forms involves dripping, pouring, sprinkling or other mechanisms of delivering water to the soil, wherein it enters the soil and seeps into the ground, thereby providing the roots of the vegetation access to needed water.

Lawns, for instance, have relatively shallow root systems. A large percentage of the watering of commercial and residential lawns ends up seeping below or beyond the reach of the roots, thus being wasted. Another problem is that the water that seeps below the roots is then available for deeper roots of unintended competitive vegetation such as many varieties of weeds.

In addition, the moistened soil loses some of its water to evaporation into the atmosphere, thus providing no benefit to the vegetation. And still further, any pest, harmful chemicals, or even competitive root systems could invade the water absorption zone of the intended target vegetation and compete for water, nutrients, and other important properties. Some exogenous forces can even potentially attack the vegetation itself.

Grade school science classes often teach students about vegetation by having the children grow small, hardy plants in glass agricultural yield jars. The inventor extends this well-understood glass agricultural yield jar concept in a series of novel innovations described herein so as to take a modified approach wherein the aforementioned challenges are specifically addressed.

These, along with several other problems, are just some of the challenges large and small-scale farmers and landscapers must address. Here, several solutions to the aforementioned problems are proposed.

### SUMMARY OF THE INVENTION

One aspect of the invention resides in an agricultural yield pod and an agricultural yield pad with root membrane overlay and a method of attaining an agricultural yield. It should be understood by those skilled in the art that the pod or pad is a three dimensional containment area of virtually any size and volume.

The method includes:
confining a growth medium within a water impermeable boundary of an agricultural yield pod or agricultural yield pad with root membrane overlay,
providing vegetation in the growth medium,
introducing nutrients and water within the boundary to reach the growth medium and thereby the vegetation; and
maintaining segregation of contents that are within the confines of the boundary from a surrounding environment.

The boundary prevents seepage of the water and nutrients beyond the boundary from within the confines. The boundary reduces evaporation of the water and nutrients from the confines over what would otherwise be the amount of evaporation without the boundary. The boundary retains the water and nutrients within the confines. The boundary is made of an agriculturally and environmentally friendly material whose presence is harmless to the surrounding environment. The boundary may be insulated.

In the case of the agricultural yield pod 10, the boundary includes a base, a sidewall and a top, the top having two access ports spaced apart from each other. In the case of the pad, the boundary includes a base and a sidewall with the root membrane overlay serving as the top.

Further, the agricultural yield pod 10 and agricultural yield pad 30 allow for precise control over the volume of water and nutrients provided to the plants to ensure entirely optimal water and nutrient conditions.

Whether the agricultural yield pod 10 or agricultural yield pad 30 is made out of glass or other agriculturally and environmentally friendly materials, and whether made for small household applications or large scale industrial applications, the drastic reduction in water and nutrients required to sustain the vegetation, reduction of the threat of competitive vegetation and external chemicals to the roots and vegetation, and increase in efficiency for the roots to access nutrients and water solve numerous common issues across the agricultural space.

### BRIEF DESCRIPTION OF THE DRAWING

For a better understanding of the present invention, reference is made to the following description and accompanying drawings, while the scope of the invention is set forth in the appended claims.

FIG. 1 is a schematic diagram that shows a water absorption zone around a vegetation root system.

FIG. 2 is a schematic diagram of a root system within a conventional glass jar.

FIG. 3 is an elevation view of an agricultural yield pod in accordance with the invention.

FIG. 4 is an elevation view of the agricultural yield pod of FIG. 3 but containing a root system of vegetation in soil with the trunk of the vegetation extending through a vegetation growth port and neck of the agricultural yield pod.

FIG. 5 is a top view of the agricultural yield pod of FIG. 3.

FIG. 6 is a bottom view of the agricultural yield pod of FIG. 3.

FIG. 7 is an elevation view of the agricultural yield pod in accordance with a further embodiment that has a water collector and entrance port and a top concave curvature.

FIG. 8 is a top view of the agricultural yield pod of FIG. 7.

FIG. 9 is an elevation view of the agricultural yield pod of FIG. 7 in accordance with another embodiment that has a bottom filter and drainage tube.

FIG. 10 is an elevation view of the agricultural yield pod of FIG. 7 in accordance with yet another embodiment that has an overflow filter and drainage tube.

FIG. 11 is an elevation view of the agricultural yield pod of FIG. 7 in accordance with still a further embodiment that has an extraction tube and filter extended from the water and nutrient port 18 to the interior bottom base of the inner cavity.

FIG. 12 is an elevation view of an agricultural yield pod in accordance with an additional embodiment having multiple vegetation ports.

FIG. 13 is an elevation view of an agricultural yield pod in accordance with an insulating embodiment that has a thermal insulator barrier between outer and inner impermeable boundaries.

FIG. 14 is an elevation view of an agricultural yield pod as in FIG. 13, but with an opening that provides access to the space between the out and inner impermeable boundaries.

FIG. 15 is an elevation view of an agricultural yield pod in accordance with an insulating embodiment that has an electric heating coil between outer and inner impermeable boundaries.

FIG. 16 is a schematic representation of an electric heating coil used in FIG. 15.

FIG. 17 is an elevation view of an agricultural yield pad containing multiple root systems and closed by a root membrane with many vegetation ports (and without vegetation necks).

FIG. 18 is a top view of the root membrane closing the agricultural yield pad 30 of FIG. 17.

FIG. 19 is an elevation view of the agricultural yield pad of FIG. 17 with the root membrane attached to the uppermost portion of the agricultural yield pad sidewall.

FIG. 20 is an elevation view if the agricultural yield pad of FIG. 19 but with the root membrane attached instead to the middle region of the agricultural yield pad sidewall.

FIG. 21 is an elevation view of the agricultural yield pad with root direction channels 38.

FIG. 22 is an elevation diagram of stacked shelves with agricultural yield pads with crops.

FIG. 23 is an elevation view of three agricultural yield pads created for specific vegetation sizes and containing crops different from each other.

FIG. 24 is an elevation view of a conventional manner of providing stability or support to a tree.

FIG. 25 is an elevation view of the agricultural yield pod of FIG. 3 equipped with a tree trunk brace.

FIG. 26 is an elevation view of the agricultural yield pod of FIG. 25 that is equipped with a tree trunk brace in use bracing a tree trunk.

FIG. 27 is an elevation view of the agricultural yield pod of FIG. 3 equipped with an umbrella shaped protector.

FIG. 28 is an elevation view of the agricultural yield pod of FIG. 27 that is equipped with the umbrella shaped protector in use protecting vegetation.

FIG. 29 is an elevation view of multiple agricultural yield pods of FIG. 3 individually containing the root system of an individual tree and allowing the trunk of the tree to extend upward through a respective vegetation port.

FIG. 30 is an elevation view of a Pad of FIG. 7 containing the root system of multiple trees and allowing the trunks of the trees to extend upward through root membrane openings sized appropriately.

FIG. 31 is an elevation view a lawn within agricultural yield pad of FIG. 20.

FIG. 32 is an elevation view of a lawn within the agricultural yield pad of FIG. 19.

### DESCRIPTION OF THE PREFERRED EMBODIMENT

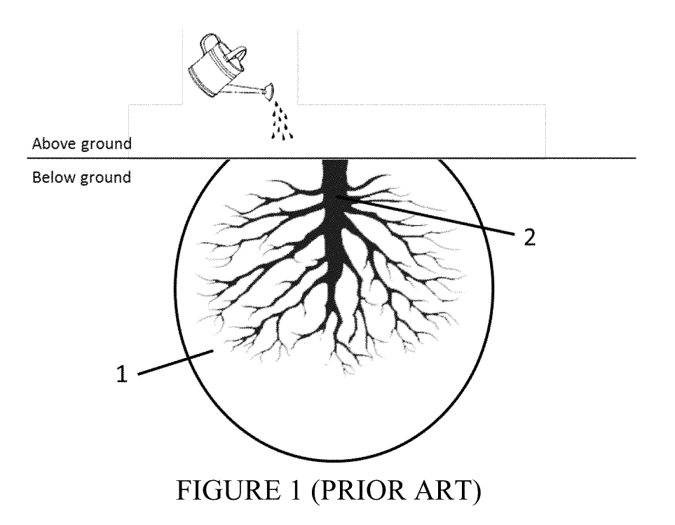

In FIG. 1, the moisture zone, or absorption zone 1, in the soil as a result of watering is shown. As the water gets absorbed into the ground around the root system, the vegetation absorbs what it needs. However, some of the water continues to seep below and/or beyond the reach of the roots 2, thus not providing benefit to the vegetation. Even within the water absorption zone 1 around the roots 2, some of the water is not in near proximity to the roots and thus does not provide direct benefit to the vegetation.

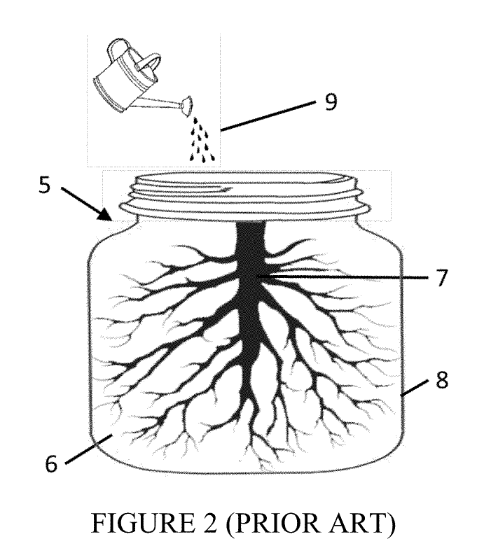

Turning to FIG. 2, when a glass jar 5 contains sufficient growth medium 6 (e.g., soil), vegetation of various forms can thrive. As the roots 7 grow and reach the inside surface of the glass jar, they are unable to grow beyond the boundary 8 of the glass and thus increase their growth within the growth medium 6 encapsulated by the glass jar 5. As such, the volume of soil will eventually contain a far greater density of root matter per cubic unit of growth medium than when there is no glass pod. As a result, the roots 8 are in contact with more of the contained growth medium 6 and can extract more of the contained nutrients per unit of volume and can extract more of the water (and nutrients) contained within. Further, any water 9 introduced into the glass jar cannot seep beyond the boundary 8 of the glass and thus cannot seep beyond the reach of the roots 7. The result is that less water is required and the system is more efficient than an uncontained system. Obviously, the same is true for other nutrients.

Encapsulated Agricultural Yield Pod

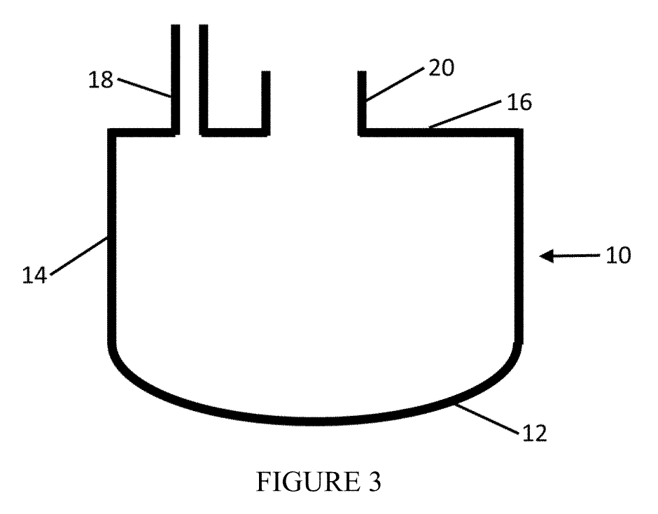

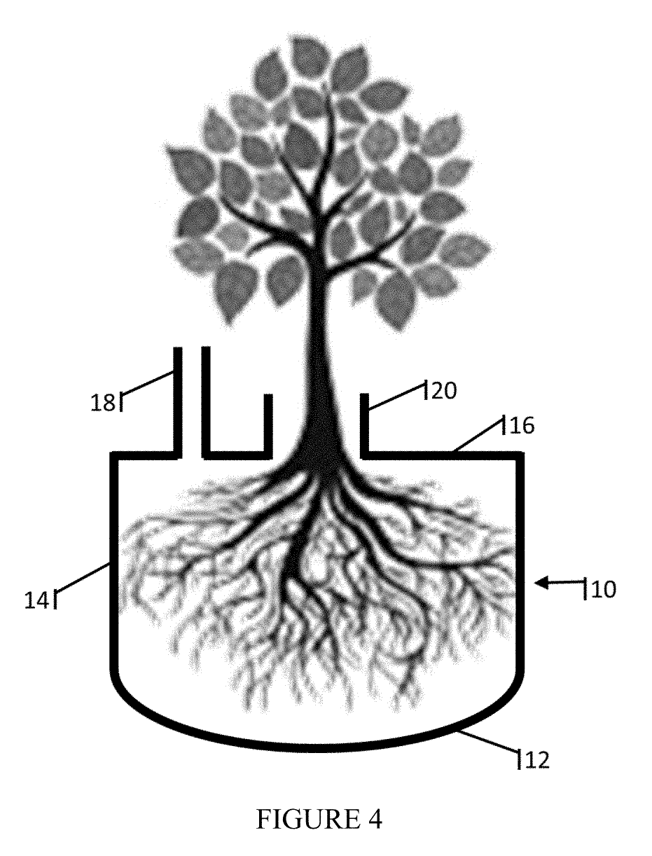

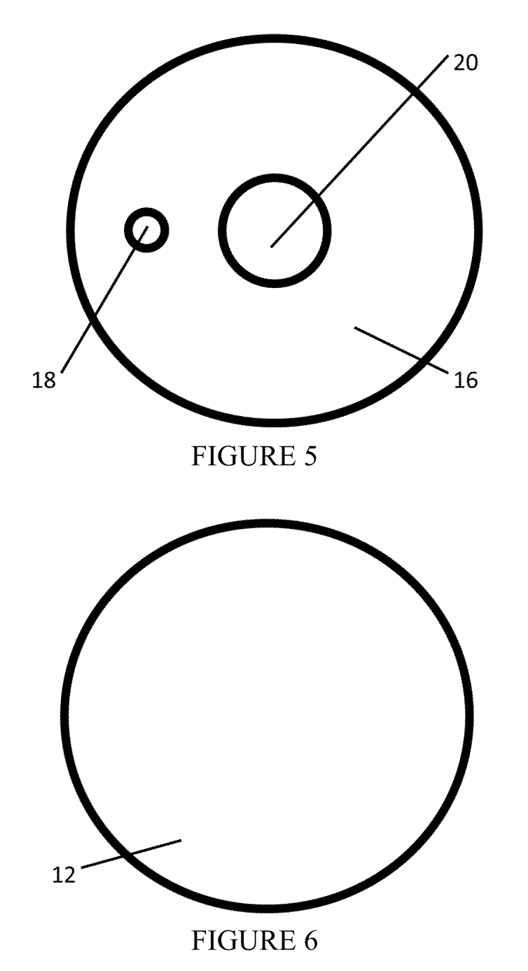

An agricultural yield pod 10 of any shape (cube, spherical, oblong, etc.) is made of any environmentally compatible and agriculturally compatible medium such as glass, with several ports, is introduced. The agricultural yield pod 10 has a bottom 12, sidewall 14 and top 16 that together constitute a boundary defining an inner cavity. The top 14 has at least two ports that are:
1) A water and nutrient port 18 for the introduction of water and nutrients, and access to the growth medium for watering, testing, replacement, and/or replenishment; and
2) A vegetation growth port 20 (or neck), through which the trunk and/or above ground growth of the vegetation protrudes. See FIGS. 3, 4, 5, and 6.

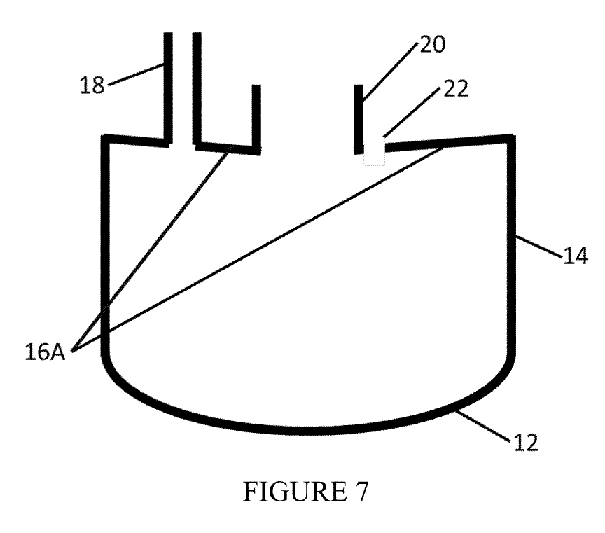

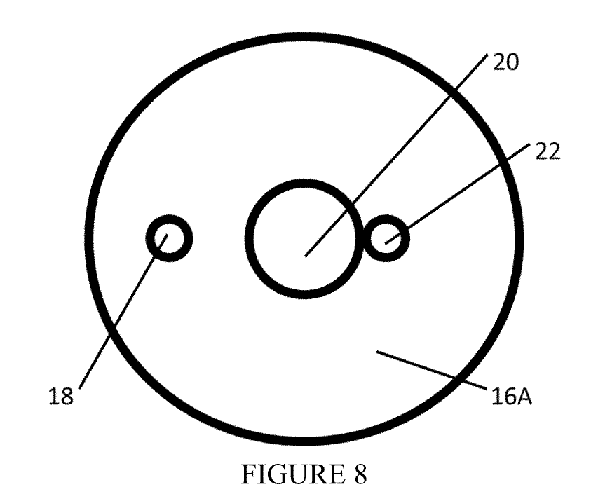

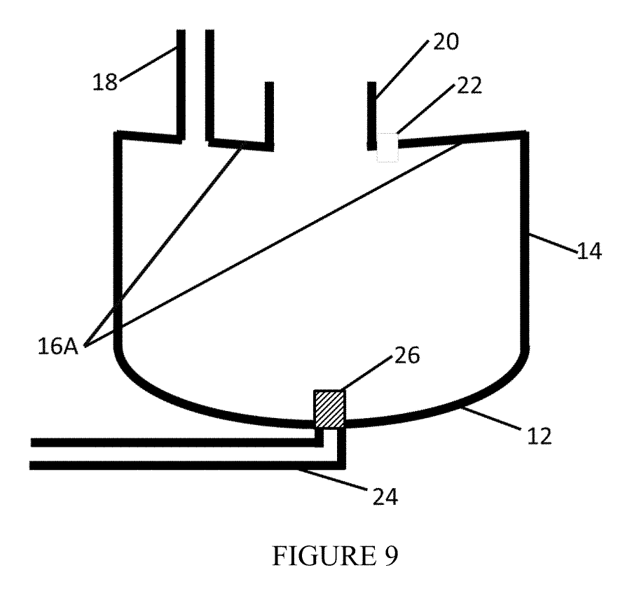

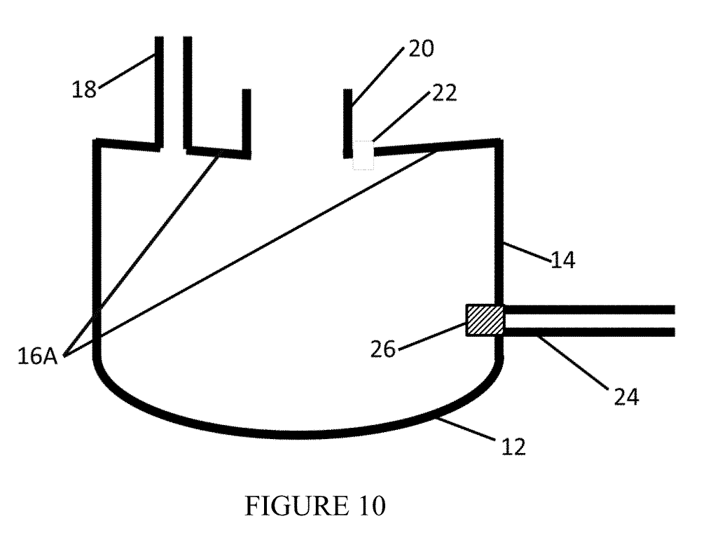

The agricultural yield pod 10 may have two additional ports that serve additional purposes while also solving additional problems, namely:
1) A rain/sprinkler water entrance port 22 formed in the top 16 of the agricultural yield pod, preferably with the top 16 having a curvature in a concave manner wherein any rain or sprinkler water can be funneled to a rain/sprinkler water entrance port 22. See FIGS. 7 and 8; and
2) A bottom or side protruding drainage port 24 with filter 26 to allow for the removal of water or other contents. See FIGS. 9 and 10.

Turning to FIG. 7, the agricultural yield pod 10 is shown having its top surface 16A curved concave inwards so as to collect rainwater, sprinkler water, or dew, which thereafter is funneled toward the rain/sprinkler water entrance port 22, thus allowing for traditional means of providing water or other nutrients.

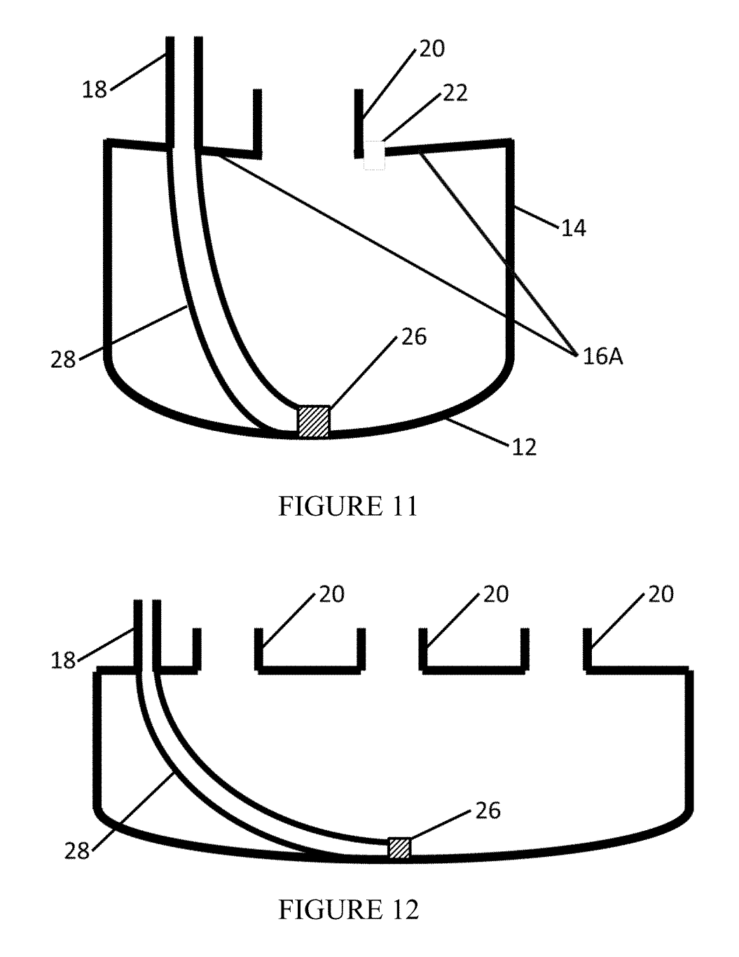

To drain contents from the interior bottom of the unit without the optional drainage ports, an extension tube 28 from the water and nutrient port 18 can be added. See FIG. 11.

The agricultural yield pod 10, as presented in FIGS. 3 through 13, can be made of transparent, semi-transparent, or non-transparent material, such as glass, that is impermeable to water, thus acting as an encapsulating boundary. The encapsulating boundary includes a bottom 12, sidewall 14 and top 16. The top 16 has a water and nutrition port 18 and a vegetation growth port 20 (or neck) spaced apart from each other. The hollow center of the agricultural yield pod 10 can be filled with a growth medium such as soil.

Seeds or saplings can be planted through the vegetation growth port 20 (or neck) or via the top 16 if the top 16 is configured to be removable. Water can be delivered through the vegetation growth port 20 (or neck) and/or through the water and nutrient port 18, and/or through the optional rain/sprinkler water entrance port 22. The water and nutrient port 18 can have a connection valve attached wherein a garden hose, PVC pipe or any other water delivery mechanism can be attached such that (i) a measured amount of water can be delivered when needed, and (ii) the water will never be exposed to the atmosphere such as in typical sprinkler systems and thus be delivered more efficiently directly into the growth medium.

As water is introduced to the agricultural yield pod 10, it cannot seep beyond the boundary of the agricultural yield pod 10 and thus solves the problem as illustrated in FIG. 1 whereby water seeps deeper into the medium beyond the reach of the roots. Hence, the agricultural yield pod 10 makes all the water more accessible than the standard practice.

By placing a cap over the water and nutrient port 18 or connecting a garden hose or PVC pipe to the end of this port 18, the problem of evaporation is vastly reduced as very little of the moistened medium is exposed to the air. Furthermore, variations of the agricultural yield pod 10 can be constructed with elongated water and nutrient port 18 and elongated Vegetation Port so that the body of the agricultural yield pod 10 can be buried deeper below the ground surface, such as below the frost line, or in other protective medium to better control temperatures. Moreover, variations of the agricultural yield pod 10 can be constructed with multiple Vegetation Ports to allow multiple plants in a single encapsulated ecosystem. See FIG. 12.

By extending the agricultural yield pod 10 to have many vegetation ports with one or more water and nutrient ports 18, all the water introduced cannot seep beyond the boundary of the agricultural yield pod 10 and thus can more effectively provide water to a wide array of vegetation simultaneously. By angling and curving the floor of the agricultural yield pod 10, any water that seeps down from the water and nutrient port 18 will tend to flow toward the center of the agricultural yield pod 10, thereby providing equal access to the water for all roots throughout the agricultural yield pod 10.

Various shapes of the agricultural yield pod 10 and various positions and counts for each type of port allow for many different kinds of extensions, all while keeping the contents of the agricultural yield pod 10 segregated from the surrounding environment. As such, any external forces, such as unwanted chemicals, pests, competitive vegetation, and the like are prevented, as is the problem of evaporation. Thus, lower amounts of water will be used while keeping the roots and the vegetation in an improved and controlled environment.

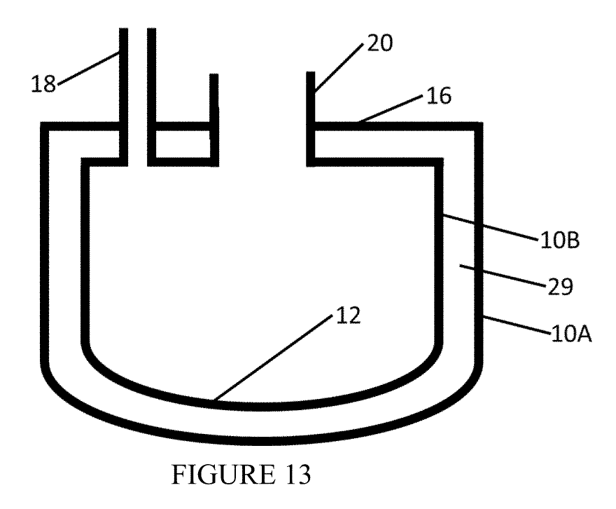

In the case of unhardy growth, which arises in some vegetation that is sensitive to some weather conditions and thus not hardy year round, such vegetation is expected to die during weather incompatible for its species. To extend the length of the season for such vegetation, an insulated version of the agricultural yield pod 10 can be constructed wherein a housing or an outer agricultural yield pod 10A contains an inner agricultural yield pod 10B and a gap 29 between is filled with insulation to maintain target content temperatures. For instance, the agricultural yield pod 10 may be double walled 10A, 10B with a cavity between that defines the gap. See FIG. 13.

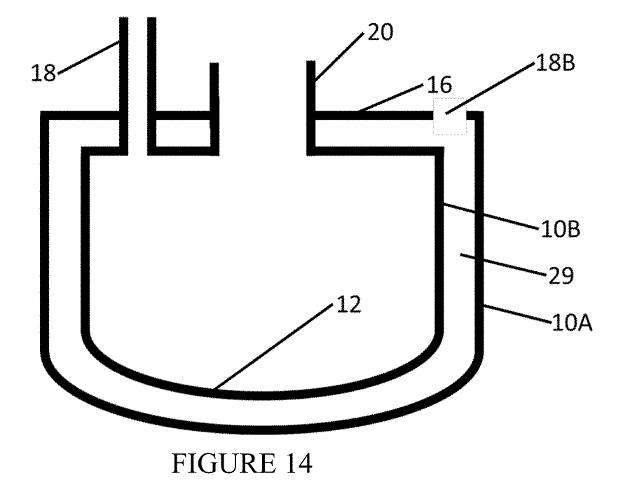

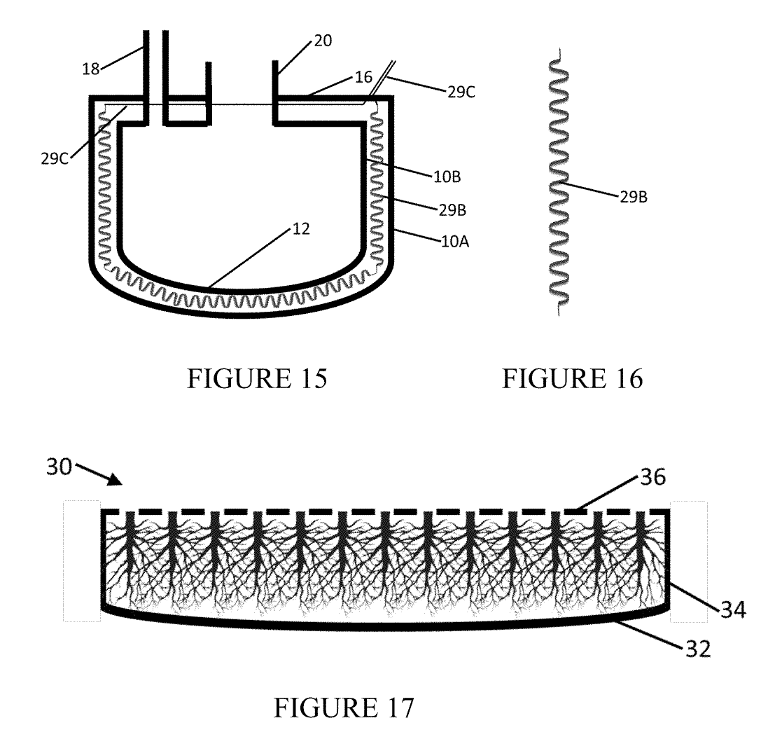

Variations include the gap being an empty cavity containing a warmer such as a conventional electric warmer, or cooler, a pump that circulates warm or cooler water for a timed cycle, or other external means of adding or removing heat. This gap can be filled via port 18B with temperature controlling liquids such as water, antifreeze, dry ice, air, or other agents. See FIG. 14. This gap can also house a electric powered electrical heating coil 29B to maintain warmth as needed. See FIGS. 15 and 16. By keeping the contents of the inner agricultural yield pod 10A to the optimal temperature, despite the ambient ground temperature, such extends the life of the otherwise unhardy growth. Thus, a walled cavity is provided that is external the contents within confines of the pod and a medium is introduced into the walled cavity such as an insulation medium, a heating medium or a cooling medium. It should be understood that such a medium is other than air at ambient temperature (but may be water or air at hotter or cooler temperatures than ambient). In addition to the insulation and warming options to provide temperature consistency for unhardy vegetation, the various ports can have extended necks allowing for the entire pod to be buried deeper below ground, further from the ambient air and upper ground level temperatures, thus also ensuring less variability in the temperature of the pod and its contents.

Encapsulated Agricultural Yield Pad

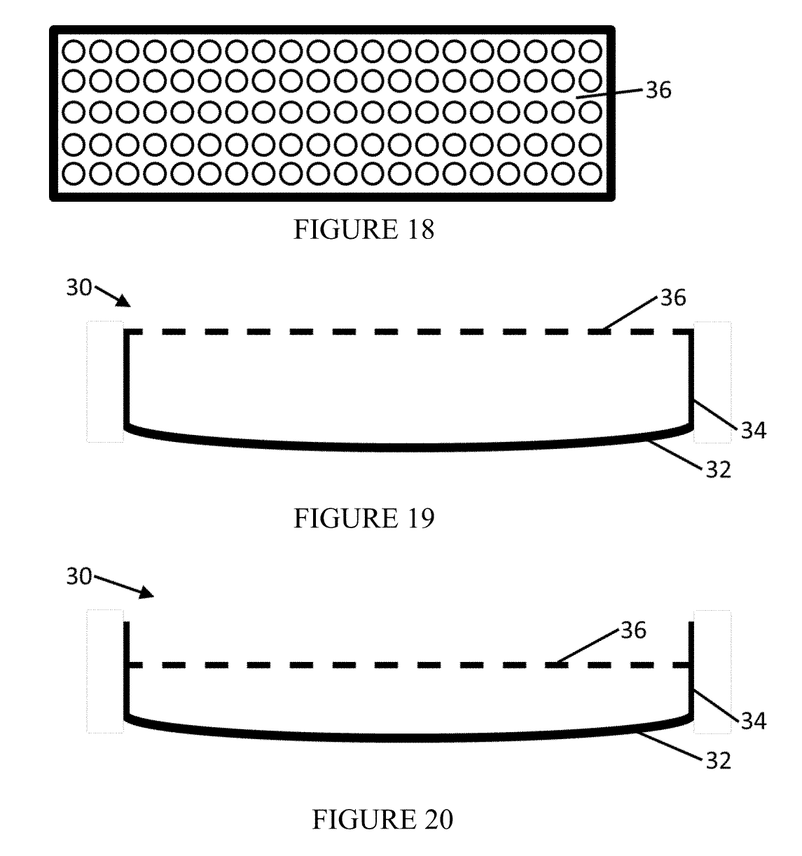

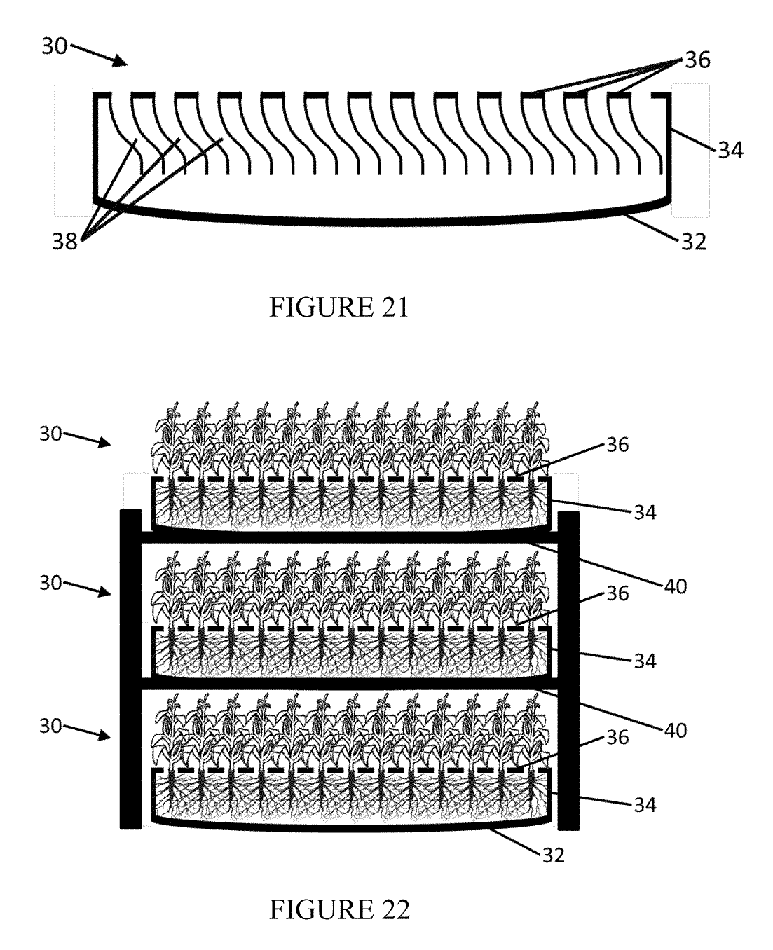

A related extension of the agricultural yield pod 10 is the agricultural yield pad 30, which can be constructed for large surface areas of vegetation such as lawns. Like the agricultural yield pod 10, the various surfaces (bottom 32 and sidewall 34) of the agricultural yield pad 30 keep water from seeping beyond the roots, and thus an agricultural yield pad 30 can be constructed in much the same fashion. See FIGS. 17 and 18.

This agricultural yield pad 30 may have many vegetation ports but need not be constructed with vegetation necks that protrude upwards for use in applications such as lawns. Instead, a holed root membrane overlay 36 is used that is strictly a plate with holes through which the vegetation grows. The holed root membrane overlay 36 can be attached either at the top edge of the sidewall 34 of the pad 30, as illustrated in FIG. 19, or at points lower down, such as in FIG. 20.

When the holed root membrane overlay 36 is attached in the middle, as in FIG. 19, soil is put above and below the holed root membrane overlay 36 so that applications in which the user prefers dirt be exposed can still leverage. Since a growth media is above and below the holed root membrane overlay 36, the roots are able to grow. As the roots of the vegetation above the holed root membrane overlay 36 grow and pass through the holes of the holed root membrane overlay 36 and enter the soil and growth medium below the holed root membrane overlay 36, they will extract the nutrients and water from that lower zone accordingly. As water is added to the agricultural yield pad 30, the water seeps toward the growth medium below the holed root membrane overlay 36. Given the surface area of the holed root membrane overlay 36, the evaporation of the water in the medium below the holed root membrane overlay 36 is vastly reduced when compared to no such membrane.

The holed root membrane overlay 36 can be lifted out of the agricultural yield pad 30 or hinged onto the side of the agricultural yield pad 30 so it be angled out. Any vegetation, such as carrots or beets, growing in the lower zone of the agricultural yield pad 30 can be automatically harvested by lifting the holed root membrane overlay 36. Furthermore, by being able to lift the holed root membrane overlay 36, such allows the user to clean out the contents of the lower zone of the agricultural yield pad 30 and put in fresh growth media. By then replacing the holed root membrane overlay 36 back into the pad, the user can either plant seeds or saplings directly into the holes or place another layer of growth medium above the holed root membrane overlay 36 and plant seeds of saplings in this upper zone.

A more complex version of the agricultural yield pad 30 can be constructed where the holes of the holed root membrane overlay 36 have tubes protruding into the lower zone of the pad. These tubes, or root direction channels 38, direct the root growth and channel water, and allow for the roots to grab onto surfaces when such vegetation requires, such as is often beneficial for residential lawns. See FIG. 19.

When grass seeds or multiple plants are growing within the agricultural yield pad 30 with root direction channels 38, as in FIG. 20, the roots grow down the angled direction root channels 38. As water seeps down the growth medium toward the bottom of the agricultural yield pad 30, all roots continue to have access to the water. Yet the angled nature of the channels reduces the evaporative effects thus retaining more of the water than without.

In each variation of the agricultural yield pod 10 and agricultural yield pads 30, with and without the holed root membrane overlay 36 and with and without the root direction channels 38, the growth medium (e.g., soil) and the vegetation (or seeds) remain segregated from the surrounding environment. This segregation prevents water from seeping beyond its boundary, reducing evaporation, maximizing utilization of the nutrients within the growth medium, and increasing root density per cubic unit of volume.

As illustrated above, the agricultural yield pod 10 and agricultural yield pad 30 configurations serve direct purposes, solve common problems, and provide a number of areas of value to users. As user needs differ, the following preferred embodiments showcase several common and intended applications.

Farming

Typical farming applications have vegetation of many sizes with many water and nutritional needs. The agricultural yield pods 10 and pads 30 can be constructed to dimensions based on the sizes of the root systems of the intended vegetation. Rather than rely on the typical sprinkler and drip irrigation systems so common on farms, watering hoses can be attached directly to the water and nutrient ports 12 rather than to sprinkler systems, thus reducing the water loss associated with these standard watering methods, and be able to accommodate farming land areas other than circular so often used based on the center pivot irrigation systems.

Further, excess water that may accumulate in the agricultural yield pods 10 or pads 30 can be removed via the drainage ports and stored or given to other vegetation, thus reducing water wastage and total water consumption. Since the contents of the agricultural yield pods 10 and pads 30 are encapsulated from the surrounding ground, there is a reduced need for chemicals such as weed killers.

Also, each agricultural yield pad 30 and agricultural yield pod 10 can be independently tested for nutrient and soil chemical levels and thus targeted remedies can be implemented. Agricultural yield pods 10 and agricultural yield pads 30 can even be transplanted as a whole without disturbing its contents by lifting and moving the entire pod or pad. This allows for repositioning entire sections of crops, if ever needed, and even moved indoors for multi-level indoor farming, such as vertical stacking of pads on shelves 40, as in FIG. 22.

Typical farming and harvesting includes moving people and equipment to the vegetation for inspection and harvesting of the growth. The agricultural yield pods 10 and pads 30 with crops can be removed from the ground and sent via conveyor belt or other transportation means to the farmer or harvester for processing, hence bringing the crops to the harvester rather than the harvester to the crops.

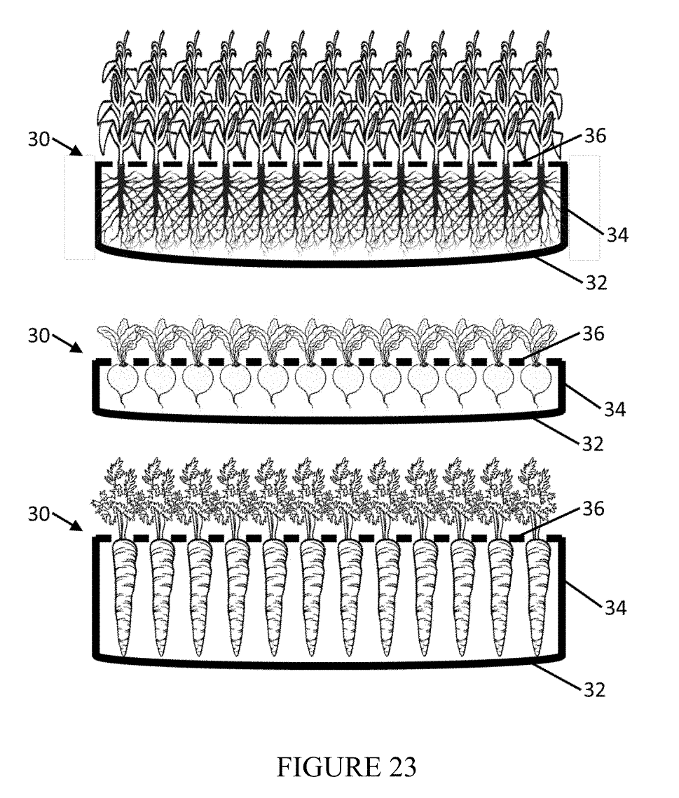

FIG. 23 is an illustrations of the Pads created for specific vegetation sizes. The top is corn, the middle beets, and the bottom carrots. To harvest the beets or carrots, one simply lifts the Root Membrane and it will automatically extract the roots accordingly. Soil is filled below the membrane and the seeds of the vegetation are planted in each of the holes.

Tree Bracing

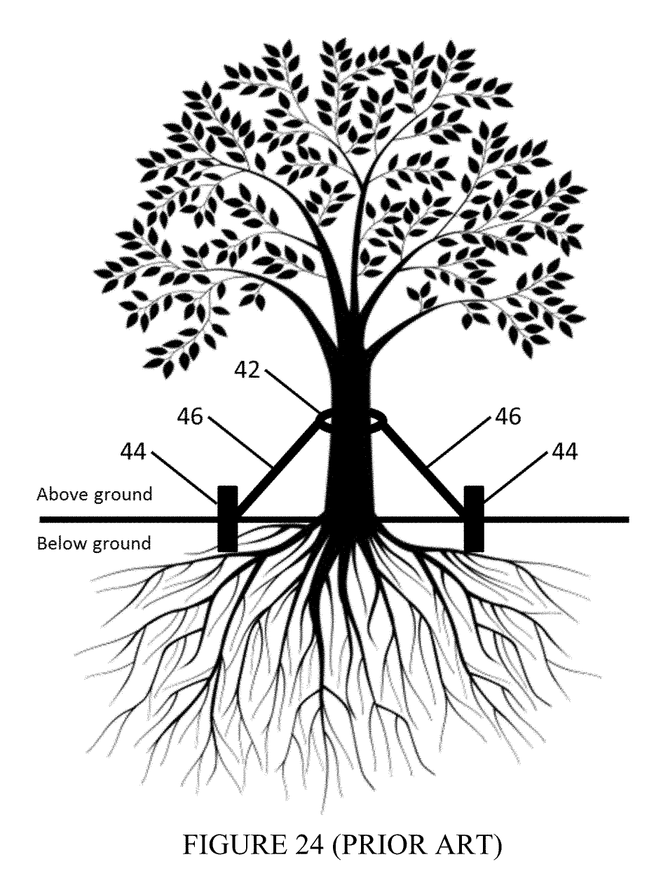

FIG. 24 shows a conventional manner for how a tree is braced with a trunk brace if there is some weakness in the structure, wind is expected that could cause damage to the trunk, or the trunk simply needs support to stay vertical.
1. A collar 42 wraps around the trunk of the tree.
2. Stakes 44 are placed in the ground.
3. Wire, rope, wood, or other structure 46 connects the stakes 44 to the collar 42.

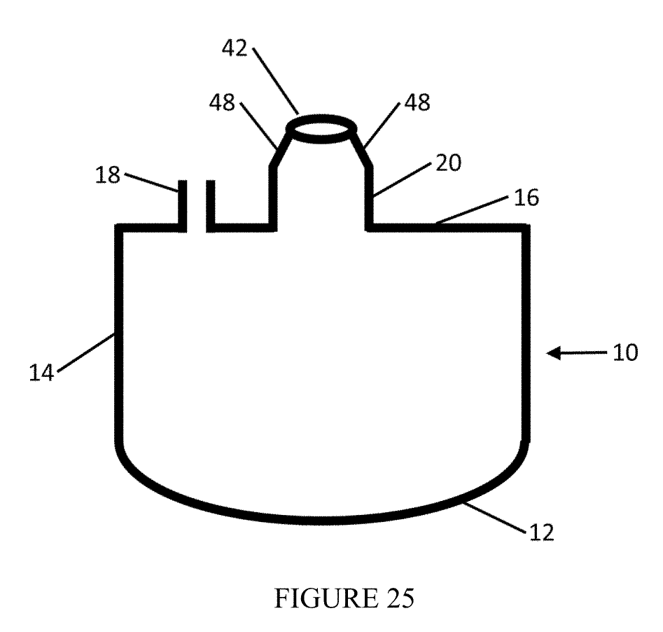

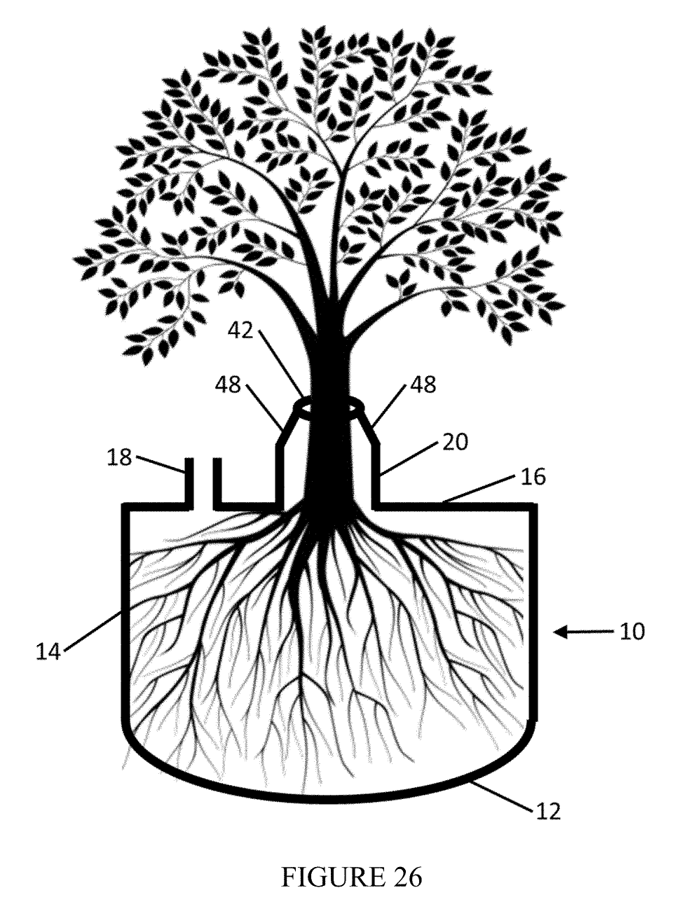

FIGS. 25-26 show an agricultural pad 30 similar to that of the agricultural yield pad 10 of FIG. 3, but having the same collar 42 of the trunk brace of FIG. 24 attached to the vegetation port 20 of FIG. 10 via a conical retainer 48. Variations of the trunk brace include braces and wiring to support to trunks/stems of plants, vines, and trees. The trunk brace has:
1. A collar 42 that wraps around the trunk of the tree.
2. At one end the agricultural yield pad 30 is affixed to the top of the vegetation port 20 and at the other end is attached to the collar 42, preferably with the conical retainer 48.

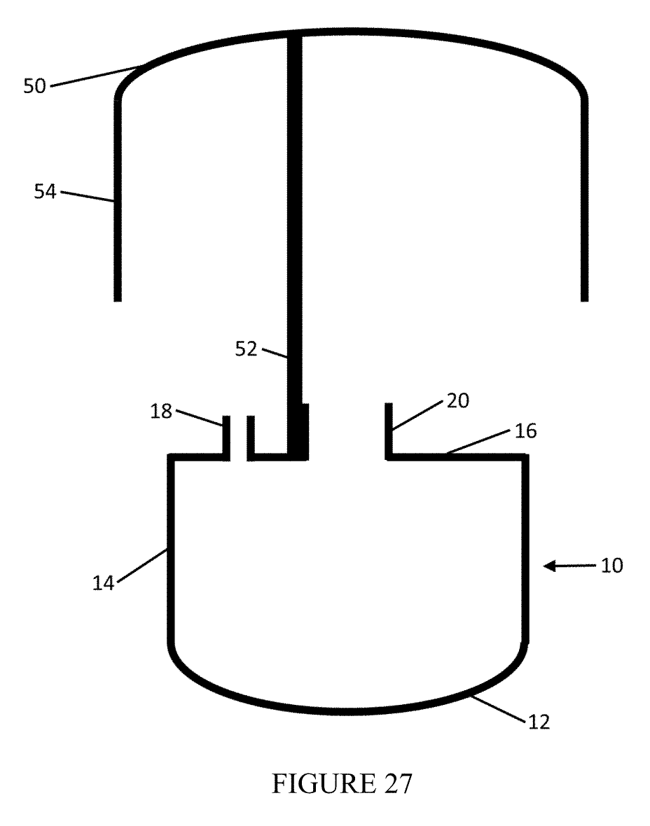

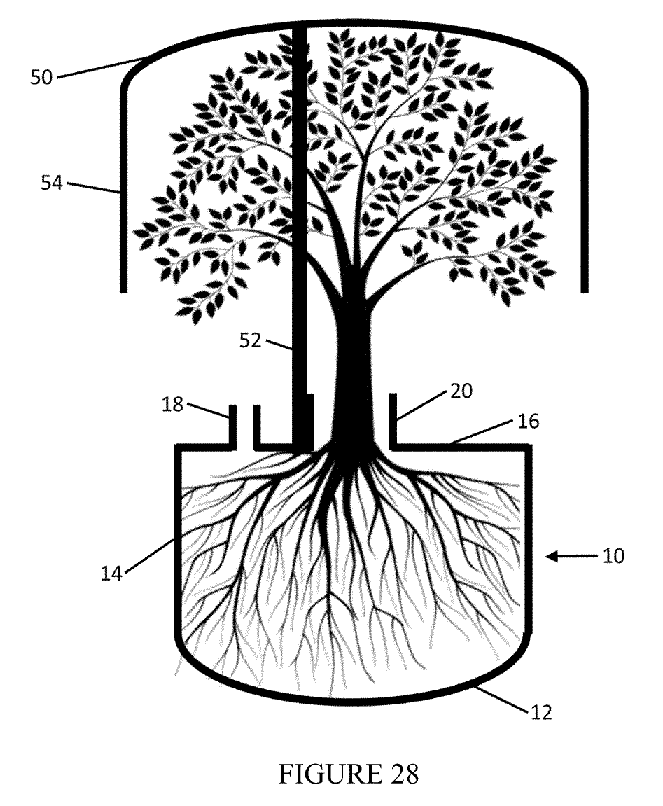

FIGS. 27 and 28 illustration the use of an agricultural yield pod 10 similar to that of FIG. 3, but an optional agricultural umbrella canopy 50 is affixed to the vegetation port 20.
1. A support or vertical shaft 52 affixed at the bottom to the vegetation port 20. The affixing may be done via any conventional fastening technique that retains or attaches or otherwise affixes two tubular pieces together including being friction fit or affixing with engaging complementary fasteners.
2. A transparent or semitransparent agricultural umbrella canopy 50 affixed at the top of the vertical shaft 52 which allows light to pass through but prevents snow, bird droppings, or other elements from falling onto the vegetation.
3. Optional agricultural umbrella wall(s) 54, which are transparent or semitransparent, affixed to the perimeter of the agricultural umbrella canopy 50, that prevent strong wind, side-falling rain, or other potentially damaging elements from coming into contact with the canopy of the vegetation.

Groves

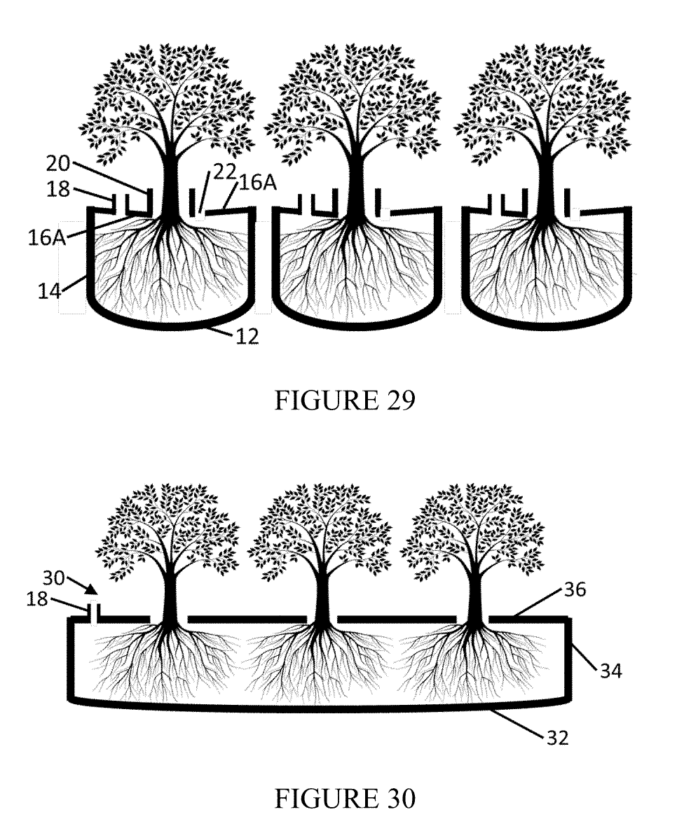

Groves of fruit trees, vineyards, and other large growth can vastly benefit by each growth having its own agricultural yield pod 10 as in FIG. 29, while connecting each via watering hoses to their respective water and nutrient port 18, or sets of such large growths in agricultural yield pads 30 as exemplified by FIG. 30. A diseased tree can be removed from the grove so as not to risk the other growth by transplanting the agricultural yield pod 10, plus any ground based infestation would be restricted to the corresponding agricultural yield pod 10. Hooks can be attached to the top of the agricultural yield pods 10 for easy and regular removal from the ground. Vegetation neck extenders can be attached to the vegetation neck of the pod to provide truck support to trees and other growth that requires vertical support structures and provide added trunk strength in times of heavy wind.

Residential

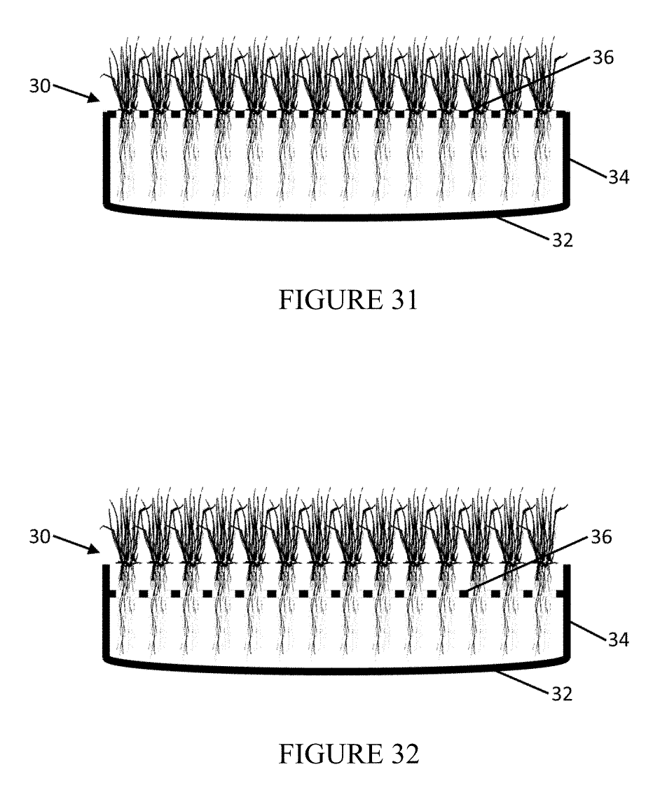

Many homeowners have lawns requiring frequent watering, nutrient treatment, and care. By having the lawn grow within an agricultural yield pad 30, homeowners will reduce water usage while also only providing nutrients to the encapsulated soil. The agricultural yield pad 30 would position the holed root membrane overlay 36 either in the middle with soil above and below the holed root membrane overlay 36 as in FIG. 32 or at the top of the with soil strictly below as in FIG. 31. This would provide a full lawn with the benefits of fully encapsulated growth, including reduction of small sink holes in the ground, ease of lawn cutting, and more even lawn heights. Contiguous areas of lawn can even grow in several adjacent Pads thus reducing the impact of disease, pest infestation, or any problem in a specific Pad, as each would have segregated contents. Residential gardens, flower beds, and other intended growth can also benefit from Agricultural yield pods 10 or pads 30 by having vastly reduced water needs, reduction in impact from animal urine, and the ability to move indoors during inclement weather.

While the foregoing description and drawings represent the preferred embodiments of the present invention, it will be understood that various changes and modifications may be made without departing from the scope of the present invention.

What is claimed is:

1. An agricultural yield apparatus, comprising:
an encapsulating container having a boundary that is impermeable to water, the boundary being made of an agriculturally and environmentally friendly material which is harmless to a surrounding natural environment, the boundary including a base, a sidewall and a top, the top having at least two access ports spaced apart from each other wherein the access ports are at least one water and nutrient port and at least one vegetation growth port, the water and nutrient port being able to deliver water and nutrients into the container; and
a growth medium within the confines of the container, wherein:
the container is configured and arranged to maintain segregation of contents of the container from the surrounding natural environment,
the bottom and sidewall are configured and arranged to retain within the container, and prevent seepage to the surrounding natural environment of, the water and nutrients, and
the top is configured and arranged to reduce an amount of evaporation of the water from confines of the container over what would otherwise be the case without the top.

2. The agricultural yield apparatus of claim 1, wherein the top has concave curvature so that with the encapsulating container in an upright orientation, the vegetation growth port extends from the top at an elevation lower than where the water and nutrient port extends from the top.

3. The agricultural yield apparatus of claim 2, wherein the top has a rain/sprinkler water entrance port adjacent to the vegetation growth port so that the concave curvature of the top promotes introduction of water from rain or sprinkler water to flow to the rain/sprinkler water entrance port and thereby enter the container.

4. The agricultural yield apparatus of claim 1, further comprising:
a drainage tube extending from an opening in the container and configured and arranged to drain a flow of excess water from the container; and
a filter configured to filter the excess water that enters the opening and is arranged neighboring the opening in a path of the flow of the excess water.

5. The agricultural yield apparatus of claim 1, further comprising:
a filter within the container; and
an extension tube that extends from the water and nutrition port into the container to the filter, which filter is configured to filter excess water from the container that enters the extension tube.

6. The agricultural yield apparatus of claim 1, further comprising:
a walled cavity encapsulating and adjacent to the boundary and that is external to the contents that are within the confines of the container, further comprising:
a medium introduced within the cavity, the medium being selected from the group consisting of an insulating medium, a heating medium and a cooling medium, the medium being other than air at ambient temperature.

7. The agricultural yield apparatus of claim 1, further comprising a plurality of items within the growth medium, the items being selected from the group consisting of seeds, saplings, grass, trees, orchards, groves, vines, crops and the roots thereof.

8. The agricultural yield apparatus of claim 1, further comprising a collar affixed to the vegetation growth port that is configured and arranged to serve as a brace for a trunk that extends through the vegetation growth port.

9. The agricultural yield apparatus of claim 1, further comprising:
an umbrella canopy over an entirety of the container; and
a support that retains the umbrella canopy in position over the container and is secured to the container.

10. An agricultural yield apparatus, comprising:
an agricultural yield pad having a boundary impermeable to water seepage and that contains growth medium, the agricultural yield pad having an open base with a sidewall;
a root membrane overlay extending from the sidewall and over the base, the root membrane overlay having a plurality of holes spaced apart from each other; and
a growth medium with the agricultural yield pad, wherein:
the agricultural yield pad is configured to maintain segregation of contents of the agricultural yield pad from the surrounding natural environment,
the agricultural yield pad is configured to prevent seepage of water and nutrients into the surrounding natural environment from within the pad,
the root membrane overlay is configured to reduce an amount of evaporation of water and nutrients from the contents of the agricultural yield pad over what would otherwise be the case without the root membrane, and
the agricultural yield pad is configured to retain water and nutrients within confines of the agricultural yield pad bounded by the root membrane overlay.

11. The agricultural yield apparatus of claim 10, wherein the sidewall terminates at an edge and the location of the root membrane overlay is selected from the group consisting of extending from the edge over the base and extending from the sidewall at a location that is spaced away from the edge.

12. The agricultural yield apparatus of claim 11, further comprising vegetation having roots that extend through at least one of the holes in the root membrane overlay.

13. The agricultural yield apparatus of claim 10, wherein the root membrane overlay is hinged to the sidewall.

14. The agricultural yield apparatus of claim 10, further comprising a plurality of root direction channels each matched with associated ones of the plurality of holes of the root membrane overlay and extending from the root membrane overlay toward the base in an obliquely angled manner until terminating spaced from the base, the growth medium being within the root direction channels, and further comprising vegetation having roots within the root direction channels.

15. The agricultural yield apparatus of claim 10, further comprising a multi-level structure having a plurality of shelves stacked one over another, the agricultural yield pad being supported on one of the shelves with the agricultural yield pad supporting the root membrane overlay.

16. The agricultural yield apparatus of claim 10, further comprising an item within the growth medium, the item being selected from the group consisting of seeds, saplings, grass, trees, orchards, groves, vines, crops and the roots thereof.

17. The agricultural yield apparatus of claim 10, further comprising:
a walled cavity encapsulating and adjacent to the boundary and that is external to the contents that are within the confines of the boundary, further comprising:
a medium introduced within the cavity, the medium being selected from the group consisting of an insulating medium, a heating medium and a cooling medium, the medium being other than air at ambient temperature.

18. A method of attaining an agricultural yield, comprising:
confining a growth medium within confines of a boundary;
providing vegetation in the growth medium;
introducing nutrients and water to the confines of the boundary to reach the growth medium and thereby the vegetation; and
maintaining segregation of contents that are within the confines of the boundary from a surrounding environment, the boundary preventing seepage of the water beyond the boundary from within the confines, the boundary reducing evaporation of the water from the confines over what would otherwise be the case without the boundary, the boundary retaining the nutrients within the confines, the boundary being made of an agriculturally and environmentally friendly material whose presence is harmless to the surrounding environment.

19. The method of claim 18, further comprising:
a walled cavity encapsulating and adjacent the boundary and that is external to the contents that are within the confines of the of the boundary, further comprising:
introducing a medium within the cavity, the medium being selected from the group consisting of an insulating medium, a heating medium and a cooling medium, the medium being other than air at ambient temperature.

20. The method of claim 18, further comprising arranging an item within the growth medium, the item being selected from the group consisting of seeds, saplings, grass, trees, orchards, groves, vines, crops and the roots thereof.
